(19) United States
(12) Patent Application Publication
(10) Pub. No.: US 2015/0339725 A1
(43) Pub. Date: Nov. 26, 2015

(54) SYSTEMS AND METHODS FOR ADVERTISING BASED ON A CONTEXT OF USE OF A COMPUTING DEVICE

(71) Applicant: Toshiba Global Commerce Solutions Holdings Corporation, Tokyo (JP)

(72) Inventors: Divya Padmanabha, Bangalore (IN); Kavita Prasad, Bangalore (IN); Prakash Krishnan, Bangalore (IN)

(73) Assignee: Toshiba Global Commerce Solutions Holdings Corporation, Tokyo (JP)

(21) Appl. No.: 14/285,694

(22) Filed: May 23, 2014

(51) Int. Cl. G06Q 30/02

(52) U.S. Cl. CPC G06Q 30/0269; G06Q 30/0277

(57) ABSTRACT

Systems and methods for advertising based on a context of use of a computing device are disclosed herein. According to an aspect, a method includes receiving advertisement content for presentation on a computing device. The method also includes determining a context of use of the computing device by a user. Further, the method includes determining supplemental content for presentation with the advertisement content based on the context of use. The method also includes presenting the advertisement content and the supplemental content via the computing device.

### TECHNICAL FIELD

The present invention relates to advertising. More particularly, the present invention relates to systems and methods for advertising based on a context of use of a computing device.

### BACKGROUND

Advertising typically involves offering standard goods and services, or they can be advertisements offering special deals, such as discounts or coupons. Many companies have developed Internet websites to provide merchants with the ability to advertise their goods or services, and to offer discounts or coupons electronically. As the Internet has become more popular, merchants have found it to be an important source of new customers and repeat business.

While advertising systems have historically provided, and continue to provide, a substantial source of business traffic for merchants, the fixed form of advertising mediums and do not allow much freedom for targeting advertisements to the individual consumer. A popular way of rendering advertisements for targeting a particular user includes using browser cookies to derive particular advertisements based on the user's online activity. However, there is a need for improved techniques for targeting advertisements specifically to a computing device user.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Disclosed herein are systems and methods for advertising based on a context of use of a computing device. According to an aspect, a method includes receiving advertisement content for presentation on a computing device. The method also includes determining a context of use of the computing device by a user. Further, the method includes determining supplemental content for presentation with the advertisement content based on the context of use. The method also includes presenting the advertisement content and the supplemental content via the computing device.

### BRIEF DESCRIPTION OF THE DRAWINGS

The foregoing summary, as well as the following detailed description of various embodiments, is better understood when read in conjunction with the drawings provided herein. For the purposes of illustration, there is shown in the drawings exemplary embodiments; however, the presently disclosed subject matter is not limited to the specific methods and instrumentalities disclosed.

FIG. 1 is a block diagram of an example system for advertising based on context of user of a computing device in accordance with embodiments of the present invention;

FIG. 2 is a flowchart of an example method for advertising based on a context of use of a computing device in accordance with embodiments of the present invention; and

FIG. 3 is a flowchart of another example method for advertising based on a context of use of a computing device in accordance with embodiments of the present invention.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

As referred to herein, the term “computing device” should be broadly construed. It can include any type of device including hardware, software, firmware, the like, and combinations thereof. A computing device may include one or more processors and memory or other suitable non-transitory, computer readable storage medium having computer readable program code for implementing methods in accordance with embodiments of the present invention. A computing device may be, for example, retail equipment such as POS equipment. In another example, a computing device may be a server or other computer located within a retail environment and communicatively connected to other computing devices (e.g., POS equipment or computers) for managing accounting, purchase transactions, and other processes within the retail environment. In another example, a computing device may be a mobile computing device such as, for example, but not limited to, a smart phone, a cell phone, a pager, a personal digital assistant (PDA), a mobile computer with a smart phone client, or the like. In another example, a computing device may be any type of wearable computer, such as a computer with a head-mounted display (HMD). A computing device can also include any type of conventional computer, for example, a laptop computer or a tablet computer. A typical mobile computing device is a wireless data access-enabled device (e.g., an iPHONE® smart phone, a BLACKBERRY® smart phone, a NEXUS ONE™ smart phone, an iPAD® device, or the like) that is capable of sending and receiving data in a wireless manner using protocols like the Internet Protocol, or IP, and the wireless application protocol, or WAP. This allows users to access information via wireless devices, such as smart phones, mobile phones, pagers, two-way radios, communicators, and the like. Wireless data access is supported by many wireless networks, including, but not limited to, CDPD, CDMA, GSM, PDC, PHS, TDMA, FLEX, ReFLEX, iDEN, TETRA, DECT, DataTAC, Mobitex, EDGE and other 2G, 3G, 4G and LTE technologies, and it operates with many handheld device operating systems, such as PalmOS, EPOC, Windows CE, FLEXOS, OS/9, JavaOS, iOS and Android. Typically, these devices use graphical displays and can access the Internet (or other communications network) on so-called mini- or micro-browsers, which are web browsers with small file sizes that can accommodate the reduced memory constraints of wireless networks. In a representative embodiment, the mobile device is a cellular telephone or smart phone that operates over GPRS (General Packet Radio Services), which is a data technology for GSM networks. In addition to a conventional voice communication, a given mobile device can communicate with another such device via many different types of message transfer techniques, including SMS (short message service), enhanced SMS (EMS), multi-media message (MMS), email WAP, paging, or other known or later-developed wireless data formats. Although many of the examples provided herein are implemented on smart phone, the examples may similarly be implemented on any suitable computing device, such as a computer.

As referred to herein, the term “user interface” is generally a system by which users interact with a computing device. A user interface can include an input for allowing users to manipulate a computing device, and can include an output for allowing the computing device to present information and/or data, indicate the effects of the user's manipulation, etc. An example of a user interface on a computing device includes a graphical user interface (GUI) that allows users to interact with programs or applications in more ways than typing. A GUI typically can offer display objects, and visual indicators, as opposed to text-based interfaces, typed command labels or text navigation to represent information and actions available to a user. For example, a user interface can be a display window or display object, which is selectable by a user of a computing device for interaction. The display object can be displayed on a display screen of a computing device and can be selected by and interacted with by a user using the user interface. In an example, the display of the computing device can be a touch screen, which can display the display icon. The user can depress the area of the display screen where the display icon is displayed for selecting the display icon. In another example, the user can use any other suitable user interface of a computing device, such as a keypad, to select the display icon or display object. For example, the user can use a track ball or arrow keys for moving a cursor to highlight and select the display object.

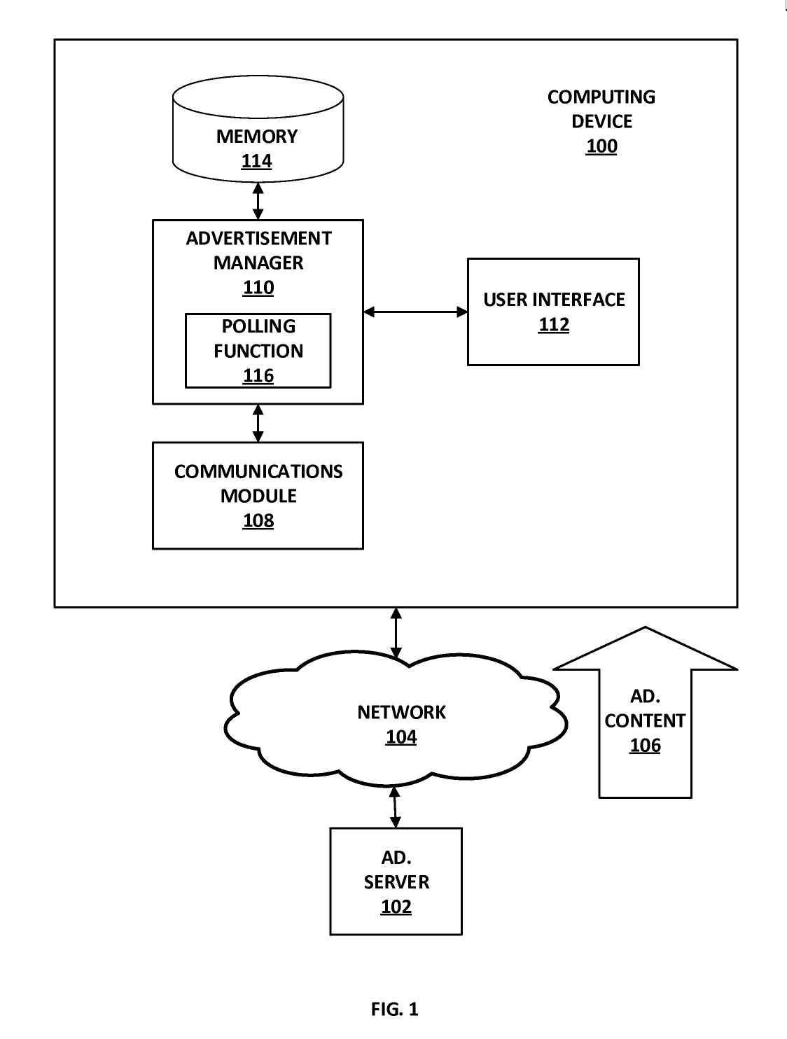

FIG. 1 illustrates a block diagram of an example system for advertising based on context of user of a computing device in accordance with embodiments of the present invention. Referring to FIG. 1, the system includes a computing device 100 and an advertisement server 102 communicatively connected via a network 104. The advertisement server 102 may be a web server configured to generate advertisement content for presentation on computing devices, such as the computing device 100. The network 104 may be the Internet. Alternatively, for example, the network 104 may include one or more suitable networks configured to communicate data between computing devices and servers. The advertisement server 102 may communicate the generated advertisement content 106 to the computing device 100 via the network 104.

Advertisement content may include text, images, video, and the like intended to promote products and/or services to consumers. The advertisement server 102 may use the network 104 to email, text, or otherwise deliver advertisement content to computing devices. For example, advertising may include search engine marketing, social media marketing, mobile advertising, or the like. In another example, the advertisement content may be presented with online content.

The computing device 100 may include a communications module 108 configured to receive data via the network 104. For example, the communications module 108 may receive a communication including advertisement content from the advertisement server 102. The computing device 100 includes an advertisement manager 110 configured to receive the advertisement content from the communications module 108. Further, the advertisement manager 110 may be configured to determine a context of use of the computing device by a user of the computing device 100, determine supplemental content for presentation with the advertisement content based on the context of use, and present the advertisement content and the supplemental content via the computing device 100. The advertisement manager 110 may be implemented by hardware, software, firmware, or combinations thereof. For example, the advertisement manager 110 may be implemented by one or more processors and memory storing program instructions executable by the processor(s) for causing the computing device 100 to implement functionality described herein.

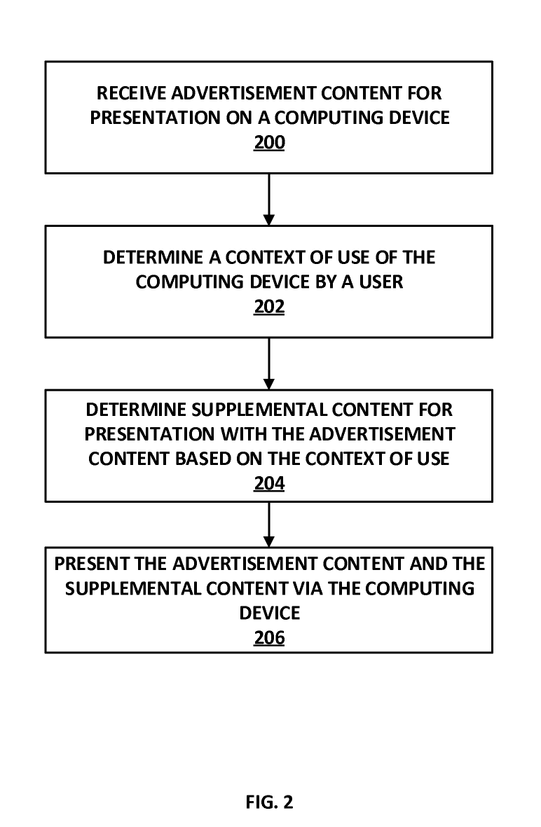

FIG. 2 illustrates a flowchart of an example method for advertising based on a context of use of a computing device in accordance with embodiments of the present invention. It is noted that in the examples described herein the method is described as being implemented by the computing device 100 shown in FIG. 1, although it should be understood that the method can be implemented by one or more other suitable types of computing devices.

Referring to FIG. 2, the method includes receiving 200 advertisement content for presentation on a computing device. For example, the computing device 100 shown in FIG. 1 may receive advertisement content 106 from the advertisement server 102 via the network 104. The advertisement content received from the advertisement server 102 may be considered to be “static” advertisement content, either entirely or partially. Static advertisement content may be advertisement content that is not changed from the state it is received to when it is presented to the user via a user interface, such as a user interface 112 of the computing device 100. The static advertisement content may be associated with an identifier that can be interpreted by the advertisement manager 110 as indicating that a particular portion or the entirety of received advertisement content is static advertisement content, thus the identified portion or whole portion of advertisement content should not be changed when presenting the content via a user interface. The advertisement manager 110 may store the received advertisement content 106 in a memory 114.

The method of FIG. 2 includes determining 202 a context of use of the computing device by a user. Continuing the aforementioned example, the advertisement manager 110 may be configured to determine one or more of a word, a sound, and an image presented via the user interface 112. For example, a display of the user interface 112 may present words or images to the user. In another example, a speaker of the user interface 112 may emit sounds of one or more words. The advertisement manager 110 may store the data for presenting the word, sound, or image in the memory 114. The stored data may indicate a context of use of the computing device 112.

In accordance with embodiments of the present invention, a context of use of the computing device may be indicated by input into the user interface of the computing device. For example, a user of the computing device 100 may input text, images, sound, and the like into the user interface 112. The advertisement manager 110 may determine input into the user interface 112. For example, the advertisement manager 110 may store the input in the memory 114. The stored input may indicate a context of use of the computing device 112. Further, the advertisement manager 110 may determine supplemental content based on the input.

In another example, the advertisement manager 110 may determine a context of use based on one or more words input by a user for communicating with another user. In an example, the advertisement manager 110 may monitor or poll a social network application residing on the computing device 100. As an example, the advertisement manager 110 may implement a polling function 116 configured to periodically poll social network activity or other activity occurring on the computing device 100 that may be indicative of a context of use. For example, the activity may be indicated by words or other content. Continuing this example, the words communicated via the social network may be used by the advertisement manager 110 for determining a context of use of the computing device 100. Further, the words may be stored in the memory 114.

The method of FIG. 2 includes determining 204 supplemental content for presentation with the advertisement content based on the context of use. Continuing the aforementioned example, the words presented by the user interface 112 or words associated with the presented words may be used as supplemental content for presentation with the advertisement content. For example, a word presented to the user a predetermined number of times via a social network application may be designated for use as supplemental content. In another example, a synonym of a word presented via the user interface may be utilized as supplemental content for subsequent presentation with the advertisement content 106.

The method of FIG. 2 includes presenting 206 the advertisement content and the supplemental content via the computing device. Continuing the aforementioned example, the advertisement manager 110 may control the user interface 112 to present the advertisement content 106 together with supplemental content. For example, the advertisement content and supplemental content may displayed on a display of the user interface 112.

In accordance with embodiments, advertisement content and supplemental content may be presented in response to receipt of the advertisement content. For example, referring to FIG. 1, the advertisement manager 110 may poll, classify, and store commonly used words on the computing device 100. The words may be stored in the memory 114. Subsequently, the advertisement server 102 may communicate the advertisement content 106 to the computing device 100. In response to receipt of the advertisement content 106, the advertisement manager 110 may combine the advertisement content 106 and one or more of the stored words in the memory 114 for presentation by the user interface 112. For example, the advertisement manager 110 may interject the stored words into the advertisement content 106. The stored words may be interjected into, for example, sentences within the advertisement content 106. In another example, one or more of the stored words may be interjected into the advertisement content 106 as an adjective for a word in the advertisement content 106. Upon receipt of the advertisement content 106, the advertisement manager 110 may interject one or more stored words into the advertisement content 106 and present the combination of content via the user interface 112.

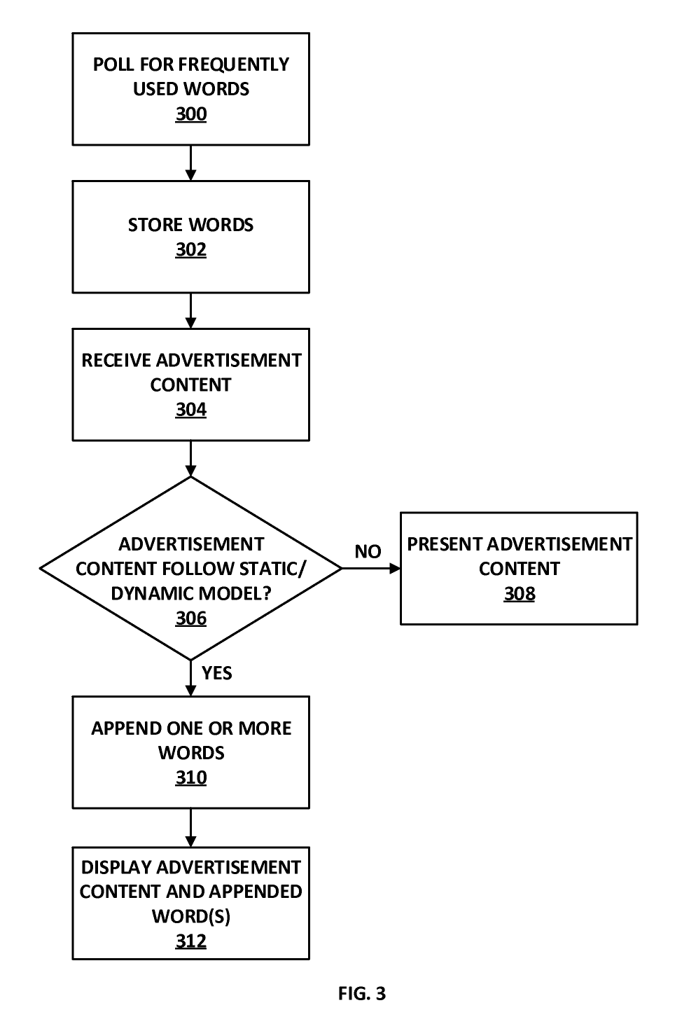

FIG. 3 illustrates a flowchart of another example method for advertising based on a context of use of a computing device in accordance with embodiments of the present invention. It is noted that in the examples described herein the method is described as being implemented by the computing device 100 shown in FIG. 1, although it should be understood that the method can be implemented by one or more other suitable types of computing devices.

Referring to FIG. 3, the method includes polling 300 for frequently used words. For example, the polling function 116 may monitor one or more applications residing on the computing device 100. In an example, the polling function 116 may periodically poll a social network application, a text messaging application, and/or an email application residing on the computing device 100. The polling function 116 may poll for words used by the user or present to the user on the monitored application. Further, the polling function 116 may determine the frequency of the use of the words over a period of time. The method includes storing 302 the frequently used words (e.g., words used more than 10 times within a day). For example, the frequently used words may be stored in the memory 114. The stored words may be organized and suitably accessible by the advertisement manager 110 for subsequent use in combination with static advertisement content for presentation to a user.

The method of FIG. 3 includes receiving 304 advertisement content. Continuing the aforementioned example, the computing device 100 may receive advertisement content 106 from the advertisement server 102. In an example, the advertisement content may be configured for presentation via a web browser or communication application (e.g., email application).

Further, the method includes determining 306 whether the advertisement content follows a static and dynamic model for presenting advertisement content. Continuing the aforementioned example, the advertisement manager 110 may determine whether the advertisement content 106 follows a static and dynamic model. As an example, the advertisement content 106 may include an indicator that indicates that the advertisement content 106 follows a static and dynamic model. The advertisement manager 110 may recognize the indicator. In the case of the content following this model as indicated by the indicator or otherwise, the advertisement manager 110 may append a dynamic advertisement to the advertisement content 106 prior to its presentation. In response to determining that the advertisement content does not follow the model, the method includes presenting 308 the advertisement content. In this case, no dynamic advertisement content or supplemental content is presented along with the advertisement content 106.

In response to determining that the advertisement content does follow the model, the method of FIG. 3 includes appending 310 one or more stored words to the advertisement content. Continuing the aforementioned example, the advertisement manager 110 may recognize the indicator, and append one or more stored words to the advertisement content 106 in accordance with embodiments of the present invention. The stored words may be considered as being dynamic advertisement content.

The method of FIG. 3 includes displaying 312 the advertisement content and the appended word(s). Continuing the aforementioned example, the advertisement manager 110 may control a display of the user interface 112 to display the advertisement content 106 along with its appended word(s).

In accordance with embodiments of the present invention, the concept of priming may be applied for selecting supplemental content for presentation along with received advertisement content. It is noted that priming can be optimized when two relevant pieces of information are presented in a similar manner. For instance, a verbal prime can work well when referencing verbal cues later, or a visual for a visual cue. As an example, related words such as “nurse” and “doctor” can create a mental connection, because they are both healthcare professionals.

Priming can introduce new concepts or bring old thoughts of an individual close to the surface of the subconscious, thus making them more accessible and more likely to be used over less accessible thoughts. There are many techniques for utilizing priming. Conceptual priming may occur when related ideas are used to prime the response. For example, “hat” may prime for “head.” Semantic priming may occur where the meaning created influences later thoughts. Non-associative semantic priming refers to related concepts but where one is less likely to trigger thoughts of another (e.g., “Sun” and “Venus”). Perceptual priming is based on the form of stimulus (e.g., where a part-picture is completed based on a picture seen earlier). Associative priming can occur when a linked idea is primed (e.g., when “bread” primes the thought of “butter”). Masked priming occurs when a word or image is presented for a very short time but is not consciously recognized. Repetitive priming occurs when the repetition of something leads to it influencing later thoughts. The dynamic advertisement content or supplemental content described herein may be generated based on the concepts of priming for making advertisements more conspicuous with an aim to draw the attention of a prospective buyer to the advertisement.

As an example of priming, a user of a computing device may frequently use the term “Dude,” and advertisement content may include the wording “where is my car.” In this example, the wording “where is my car” can be a static advertisement component, and the word “Dude” can be a dynamic advertisement component for presentation to the user. As an end result of combining the words, final advertisement may include the wording “Dude, where is my car.” It may be expected that owing to the concept of priming, the user's attention will be drawn by the additional of the frequently-used word “Dude” in the advertisement being rendered.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed:

1. A method comprising:
receiving advertisement content for presentation on a computing device;
determining a context of use of the computing device by a user;
determining supplemental content for presentation with the advertisement content based on the context of use; and
presenting the advertisement content and the supplemental content via the computing device.

2. The method of claim 1, wherein receiving advertisement content comprises receiving the advertisement content from a server.

3. The method of claim 1, wherein determining a context of use comprises determining one of a word, sound, and image presented via a user interface of the computing device, and
wherein determining supplemental content comprises determining supplemental content based on the one of the word, sound, and image.

4. The method of claim 1, wherein determining a context of use comprises determining input into a user interface of the computing device, and
wherein determining supplemental content comprises determining supplemental content based on the input.

5. The method of claim 1, wherein determining a context of use comprises determining one or more words input by a user for communicating with another user, and
wherein the supplemental content comprises the one or more words or a stored word associated with the one or more words.

6. The method of claim 1, wherein determining a context of use comprises storing one or more words presented via a user interface of the computing device, and
wherein presenting the advertisement content and the supplemental content comprises dynamically presenting the advertisement content and the stored one or more words in response to receipt of the advertisement content.

7. The method of claim 1, further comprising receiving an indicator that the advertisement content is to be accompanied by the supplemental content, and
wherein presenting the advertisement content and the supplemental content comprises presenting the advertisement content and the supplemental content in response to receiving the indicator.

8. A computing device comprising:
an advertisement manager comprising a processor and memory and configured to:
receive advertisement content for presentation on the computing device;
determine a context of use of the computing device by a user;
determine supplemental content for presentation with the advertisement content based on the context of use; and
a user interface configured to present the advertisement content and the supplemental content via the computing device.

9. The computing device of claim 8, further comprising a communications module configured to receive the advertisement content from a server.

10. The computing device of claim 8, wherein the advertisement manager is configured to:
determine one of a word, sound, and image presented via the user interface of the computing device; and
determine supplemental content based on the one of the word, sound, and image.

11. The computing device of claim 8, wherein the advertisement manager is configured to:
determine input into the user interface of the computing device; and
determine supplemental content based on the input.

12. The computing device of claim 8, wherein the advertisement manager is configured to determine one or more words input by a user for communicating with another user, and
wherein the supplemental content comprises the one or more words or a stored word associated with the one or more words.

13. The computing device of claim 8, wherein the advertisement manager is configured to store one or more words presented via the user interface, and
wherein the user interface is configured to dynamically present the advertisement content and the stored one or more words in response to receipt of the advertisement content.

14. The computing device of claim 8, wherein the advertisement manager is configured to receive an indicator that the advertisement content is to be accompanied by the supplemental content, and
wherein the user interface is configured to present the advertisement content and the supplemental content in response to receiving the indicator.

15. A computer program product comprising a computer readable storage medium having program instructions embodied therewith, the program instructions executable by a computing device to cause the computing device to:
receive, by the computing device, advertisement content for presentation on the computing device;
determine, by the computing device, a context of use of the computing device by a user;
determine, by the computing device, supplemental content for presentation with the advertisement content based on the context of use; and
present, by the computing device, the advertisement content and the supplemental content via the computing device.

16. The computer program product of claim 15, wherein the program instructions are executable by the computing device to cause the computing device to receive the advertisement content from a server.

17. The computer program product of claim 15, wherein the program instructions are executable by the computing device to cause the computing device to determine one of a word, sound, and image presented via a user interface of the computing device, and
wherein the program instructions are executable by the computing device to cause the computing device to determine supplemental content based on the one of the word, sound, and image.

18. The computer program product of claim 15, wherein the program instructions are executable by the computing device to cause the computing device to determine input into a user interface of the computing device, and
wherein the program instructions are executable by the computing device to cause the computing device to determine supplemental content based on the input.

19. The computer program product of claim 15, wherein the program instructions are executable by the computing device to cause the computing device to determine one or more words input by a user for communicating with another user, and
wherein the supplemental content comprises the one or more words or a stored word associated with the one or more words.

20. The computer program product of claim 15, wherein the program instructions are executable by the computing device to cause the computing device to store one or more words presented via a user interface of the computing device, and
wherein the program instructions are executable by the computing device to cause the computing device to dynamically present the advertisement content and the stored one or more words in response to receipt of the advertisement content.

21. The computer program product of claim 15, wherein the program instructions are executable by the computing device to cause the computing device to receive an indicator that the advertisement content is to be accompanied by the supplemental content, and
wherein the program instructions are executable by the computing device to cause the computing device to present the advertisement content and the supplemental content in response to receiving the indicator.
